(19) United States
(12) Patent Application Publication
(10) Pub. No.: US 2026/0178528 A1
(43) Pub. Date: Jun. 25, 2026

(54) SEMICONDUCTOR DEVICE AND MEMORY ACCESS METHOD

(71) Applicant: ROHM Co., Ltd., Kyoto (JP)

(72) Inventor: Atsushi Yamazaki, Kyoto (JP)

(73) Assignee: ROHM Co., Ltd., Kyoto (JP)

(21) Appl. No.: 19/424,168

(22) Filed: Dec. 18, 2025

(30) Foreign Application Priority Data
Dec. 25, 2024 (JP) 2024-229283

(51) Int. Cl. G06F 13/40

(52) U.S. Cl. CPC G06F 13/4022; G06F 13/4027

(57) ABSTRACT

A semiconductor device includes a CPU, a cache memory, and multiple memories. Each of the multiple memories is switchable between being connected to the CPU through the cache memory and being connected to the CPU without going through the cache memory.

### CROSS-REFERENCE TO RELATED APPLICATION

This application claims the priority benefit of Japan application serial no. 2024-229283, filed on December 25, 2024. The entirety of the above-mentioned patent application is hereby incorporated by reference herein and made a part of this specification.

### BACKGROUND

### Technical Field

The present disclosure relates to a semiconductor device and a memory access method.

### Related Art

In a semiconductor device such as a microcontroller as known, a memory such as a built-in memory is connected to a CPU (central processing unit) through a cache memory (e.g., see Patent Document 1: Japanese Patent Application Laid-Open No. H05-28040).

In such a semiconductor device, by temporarily storing a copy of data stored in the memory to the cache memory, the data can be placed near the CPU, and thus data access can be performed at high speed.

In the above semiconductor device, data having a size larger than the unit of access from the CPU is copied to the cache memory. Thus, in the case where a copy is not stored in advance in the cache memory, access to the copy source memory is performed and data is read from the copy source, which may result in a longer access time and cause the processing speed of the CPU to become lower than expected. Thus, the semiconductor device may not be compatible in the case of being used for an application where the processing speed is defined in advance.

### BRIEF DESCRIPTION OF THE DRAWINGS

FIG. 1 is a block diagram showing an example of a configuration of a semiconductor device according to an embodiment.

FIG. 2 is a diagram for illustrating an example of access paths from a CPU in the semiconductor device according to the embodiment.

FIG. 3 is a block diagram showing an example of a configuration of a conventional semiconductor device.

### DETAILED DESCRIPTION

Embodiments of the technique of the present disclosure provide a semiconductor device and a memory access method capable of achieving performance corresponding to an application in the access between a CPU and a memory.

Hereinafter, an example of an embodiment of the disclosed technique will be described with reference to the drawings. The dimensional ratios in the drawings are exaggerated for convenience of description and may differ from actual ratios.

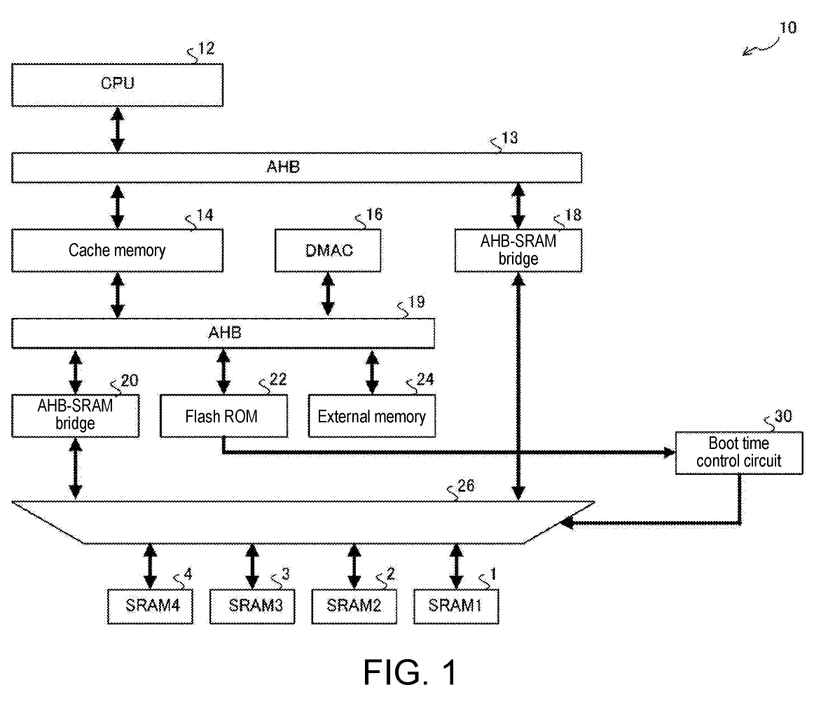

FIG. 1 shows a block diagram representing an example of a configuration of a semiconductor device 10 of the present embodiment. The semiconductor device 10 of the present embodiment includes a CPU (central processing unit) 12, a cache memory 14, a DMAC (direct memory access controller) 16, AHB (advanced high-performance bus)-SRAM (static random-access memory) bridges 18 and 20, a flash ROM (read only memory) 22, an external memory 24, a MUX (multiplexer) 26, a boot time control circuit 30, and SRAMs 1 to 4.

The CPU 12 and the AHB-SRAM bridge 18 are connected to each other through an AHB 13. The AHB-SRAM bridge 18 and the SRAMs 1 to 4 are connected to each other through the MUX 26. That is, each of the SRAMs 1 to 4 is connectable to the CPU 12 by the AHB-SRAM bridge 18.

In addition, the CPU 12 and the cache memory 14 are connected to each other through the AHB 13. The cache memory 14 temporarily stores copies of data stored in the SRAMs 1 to 4 to place the data near the CPU 12. With the data placed near the CPU 12 in this manner, the CPU 12 is capable of accessing the data at high speed.

The cache memory 14, the DMAC 16, the AHB-SRAM bridge 20, the flash ROM 22, and the external memory 24 are connected to each other through an AHB 19. That is, each of the flash ROM 22 and the external memory 24 is connected to the CPU 12 through the cache memory 14.

In addition, the AHB-SRAM bridge 20 and the SRAMs 1 to 4 are connected to each other through the MUX 26. That is, each of the SRAMs 1 to 4 is connectable to the CPU 12 through the cache memory 14 by the AHB-SRAM bridge 20.

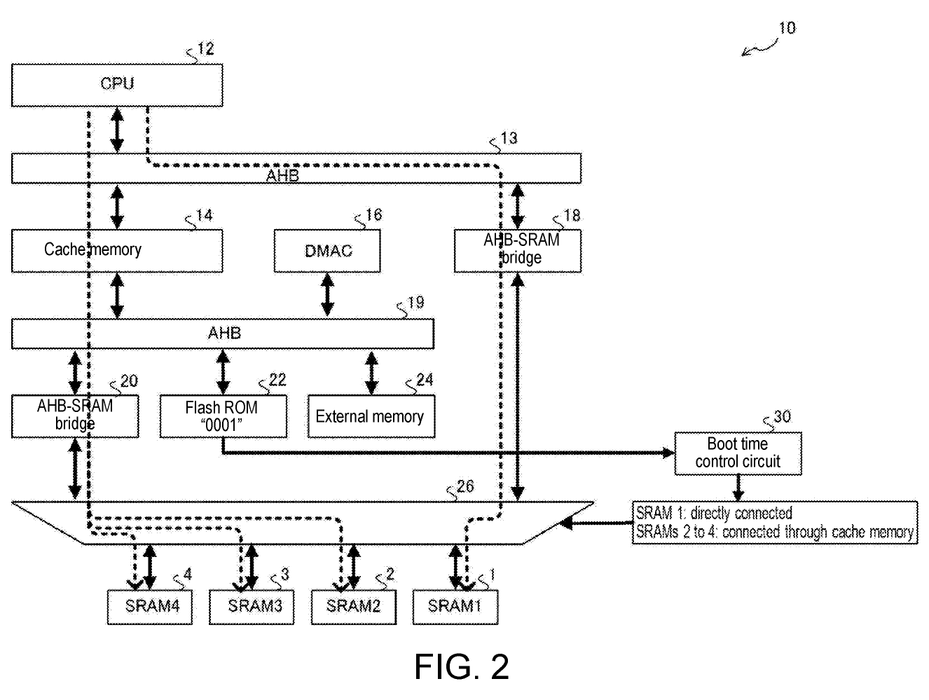

Settings for connection destinations of the SRAMs 1 to 4 are stored in advance in the flash ROM 22 according to an application of the semiconductor device 10. For example, a setting value “0” is set in the case of connecting through the cache memory 14, and a setting value “1” is set in the case of connecting without going through the cache memory 14. The flash ROM 22 of the present embodiment is an example of a setting part of the present disclosure. In this case, for example, upon setting “0001” in the flash ROM 22, as shown in FIG. 2, the SRAM 1 is connected to the CPU 12 without going through the cache memory 14, and each of the SRAMs 2 to 4 is connected to the CPU 12 through the cache memory 14. In FIG. 2, the access paths from the CPU 12 to the SRAMs 1 to 4 are shown by dotted lines.

The boot time control circuit 30 refers to the setting value set in the flash ROM 22 at startup, i.e., at boot time, of the semiconductor device 10 and sets the connection destination of each of the SRAMs 1 to 4 in the MUX 26. In the example shown in FIG. 2, referring to the setting value “0001” set in the flash ROM 22, the boot time control circuit 30 sets the SRAM 1 to be directly connected to the CPU 12 without going through the cache memory 14, specifically, to be connected to the AHB-SRAM bridge 18. In addition, the boot time control circuit 30 sets each of the SRAMs 2 to 4 to be connected to the CPU 12 through the cache memory 14, specifically, to be connected to the AHB-SRAM bridge 20.

According to the setting performed by the boot time control circuit 30, the MUX 26 switches, for each of the SRAMs 1 to 4, whether the SRAMs 1 to 4 are connected to the CPU 12 through the cache memory 14 or connected to the CPU 12 without going through the cache memory 14. The MUX 26 of the present embodiment is an example of a switching part of the present disclosure.

According to the switching of the MUX 26, in the case of the example shown in FIG. 2, the SRAM 1 connected to the CPU 12 without going through the cache memory 14 becomes accessible from the CPU 12 without depending on the state of the cache memory 14. Specifically, the processing speed is determined depending on the unit (e.g., 1 to 4 bytes) of access from the CPU 12, without depending on the access unit (e.g., 16 bytes or 32 bytes or more) of the cache memory 14. Thus, in the case where the CPU 12 accesses the SRAM 1, it becomes possible to access at constant speed. It becomes possible for the CPU 12 to execute a program at constant speed.

Thus, in the case of using the semiconductor device 10 for motor control or the like, according to an application where the processing amount of the CPU 12 within a particular time is defined, setting is performed in the flash ROM 22 such that one or more SRAMs among the SRAMs 1 to 4 required for the application are connected to the CPU 12 without going through the cache memory 14.

As described above, the semiconductor device 10 of the present embodiment includes the CPU 12, the cache memory 14, and the SRAMs 1 to 4. Each of the SRAMs 1 to 4 of the semiconductor device 10 is switchable between being connected to the CPU 12 through the cache memory 14 and being connected to the CPU 12 without going through the cache memory 14.

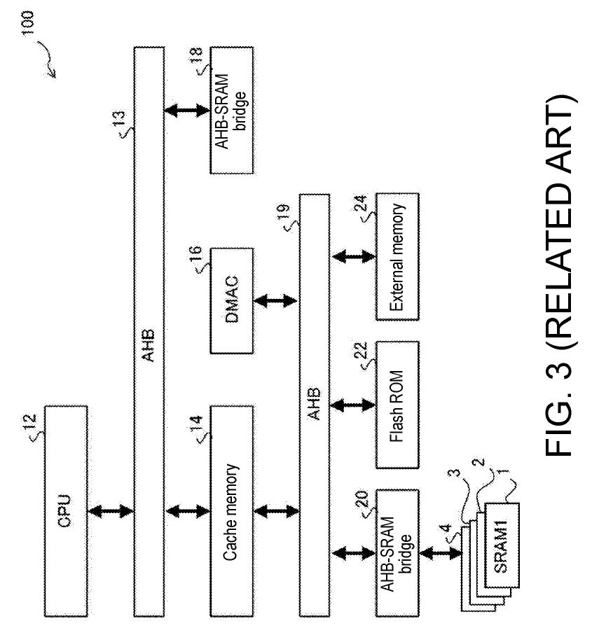

In addition, in a conventional semiconductor device 100 shown in FIG. 3, since each of the SRAMs 1 to 4 is connected to the CPU 12 only through the cache memory 14, unlike the semiconductor device 10 of the present embodiment, there may be cases where the semiconductor device 100 is not fully compatible with an application where the processing amount of the CPU 12 within a particular time is defined.

In contrast, in the semiconductor device 10 of the present embodiment, according to the application, each of the SRAMs 1 to 4 is capable of being switched between being connected to the CPU 12 through the cache memory 14 and being connected to the CPU 12 without going through the cache memory 14. Thus, according to the semiconductor device 10 of the present embodiment, performance corresponding to the application can be achieved in the access to the SRAMs 1 to 4 by the CPU 12.

In the above embodiment, it has been described that the semiconductor device 10 includes four SRAMs, but the number of SRAMs included in the semiconductor device 10 is not limited to four. The number of SRAMs may also be three or less, or may also be five or more. In addition, the embodiment is not limited to SRAMs, and may also include other memories.

In addition, each of the above embodiments is simply illustrative, and any changes or improvements may be applied.

In addition, one or multiple elements included in one embodiment among the multiple embodiments may be combined with one or multiple elements included in other embodiments among the multiple embodiments.

### Supplementary Items

### Supplementary Item 1

A semiconductor device including:

a CPU;

a cache memory; and

multiple memories, in which

each of the multiple memories is switchable between being connected to the CPU through the cache memory and being connected to the CPU without going through the cache memory.

### Supplementary Item 2

The semiconductor device according to Supplementary Item 1, further including:

a setting part configured to set a connection destination for each of the multiple memories; and

a switching part configured to switch, for each of the multiple memories, whether the memory is connected to the CPU through the cache memory or connected to the CPU without going through the cache memory, according to the setting of the setting part.

### Supplementary Item 3

The semiconductor device according to Supplementary Item 1 or 2, in which

each of the multiple memories is an SRAM.

### Supplementary Item 4

A memory access method including:

switching, by a switching part according to a setting for each of multiple memories, whether the memory is connected to a CPU through a cache memory or connected to the CPU without going through the cache memory.

What is claimed is:

1. A semiconductor device comprising:
a CPU;
a cache memory; and
a plurality of memories, wherein
each of the plurality of memories is switchable between being connected to the CPU through the cache memory and being connected to the CPU without going through the cache memory.

2. The semiconductor device according to claim 1, further comprising:
a setting part configured to set a connection destination for each of the plurality of memories; and
a switching part configured to switch, for each of the plurality of memories, whether the memory is connected to the CPU through the cache memory or connected to the CPU without going through the cache memory, according to the setting of the setting part.

3. The semiconductor device according to claim 1, wherein
each of the plurality of memories is an SRAM.

4. The semiconductor device according to claim 1, wherein
the memory connected to the CPU without going through the cache memory is connected to a bridge.

5. A memory access method comprising:
switching, by a switching part according to a setting for each of a plurality of memories, whether the memory is connected to a CPU through a cache memory or connected to the CPU without going through the cache memory.

6. The memory access method according to claim 5, further comprising:
setting, by a setting part, a connection destination for each of the plurality of memories,
wherein the step of switching, by the switching part according to the setting for each of the plurality of memories, whether the memory is connected to the CPU through the cache memory or connected to the CPU without going through the cache memory comprises:
switching, for each of the plurality of memories, whether the memory is connected to the CPU through the cache memory or connected to the CPU without going through the cache memory, according to the setting of the setting part.

7. The memory access method according to claim 5, wherein
each of the plurality of memories is an SRAM.

8. The memory access method according to claim 5, wherein
the memory connected to the CPU without going through the cache memory is connected to a bridge.
